(19) United States
(12) Patent Application Publication
(10) Pub. No.: US 2017/0075784 A1
(43) Pub. Date: Mar. 16, 2017

(54) INFORMATION PROCESSING APPARATUS, TESTING SYSTEM, INFORMATION PROCESSING METHOD, AND COMPUTER-READABLE RECORDING MEDIUM

(71) Applicant: KABUSHIKI KAISHA TOSHIBA, Tokyo (JP)

(72) Inventors: Fukutomo NAKANISHI, Tokyo (JP); Hiroyoshi HARUKI, Kawasaki (JP); Satoshi AOKI, Tokyo (JP); Fangming ZHAO, Tokyo (JP); Tatsuyuki MATSUSHITA, Tokyo (JP); Ryotaro HAYASHI, Hiratsuka (JP); Toshinari TAKAHASHI, Tokyo (JP)

(73) Assignee: KABUSHIKI KAISHA TOSHIBA

(21) Appl. No.: 15/260,933

(22) Filed: Sep. 9, 2016

(30) Foreign Application Priority Data
Sep. 15, 2015 (JP) 2015-181816

(51) Int. Cl. G06F 11/263; G06F 11/36

(52) U.S. Cl. CPC G06F 11/263; G06F 11/3684; G06F 11/3688; G06F 11/3692

(57) ABSTRACT

An information processing apparatus includes a result acquiring unit configured to acquire a pair of first test data fed to the test object and a determination result indicating an operating state of the test object when the first test data is fed, and a generating unit configured to generate second test data based on the pair of the first test data and the determination result. The generating unit is configured to select two pieces of first test data with different determination results, and to generate the second test data by generating the test data within an intermediary area between the two selected pieces of the first test data more frequently than the test data outside of the intermediary area.

### CROSS-REFERENCE TO RELATED APPLICATIONS

This application is based upon and claims the benefit of priority from Japanese Patent Application No. 2015-181816, filed on Sep. 15, 2015; the entire contents of which are incorporated herein by reference.

### FIELD

Embodiments described herein relate generally to an information processing apparatus, a testing system, an information processing method, and a computer-readable recording medium.

### BACKGROUND

Recently, software developers have come to test whether no functional or security defect is found in computer programs having been developed. When any defect is found, the developers identify the code that causes the failure, while monitoring the internal operation of the computer program using a debugger, for example, and corrects the identified code.

When tested is a piece of equipment in which the computer program is incorporated, developers are sometimes incapable of identifying the code having caused the failure merely with a debugger. In such a case, developers use a technique called fuzzing, for example, to feed pieces of random test data to the equipment, and to acquire pieces of test data resulted in a failure and pieces of test data not resulted in a failure. The developers then analyze the boundary between the test data resulted in a failure and the test data not resulted in a failure, and infers the cause of the failure.

In order to make an accurate estimation of the boundary between the test data resulted in a failure and the test data not resulted in a failure, developers are required to adjust the values of the parameters included in the test data at a very small increment before feeding the test data to the equipment. However, because this process requires a large amount of test data to be fed into the device, efficient testing of the equipment is not quite possible.

A problem to be addressed by the embodiment is to enable efficient testing.

### BRIEF DESCRIPTION OF THE DRAWINGS

FIG. 1 is a schematic illustrating a configuration of a testing system according to a first embodiment;

FIG. 2 is a schematic illustrating a configuration of test data;

FIG. 3 is a schematic illustrating a configuration of an IPv4 packet;

FIG. 4 is a schematic illustrating an example of a test history;

FIG. 5 is a schematic illustrating a first display example of the boundary information;

FIG. 6 is a schematic illustrating a second display example of the boundary information;

FIG. 7 is a schematic illustrating a third display example of the boundary information;

FIG. 8 is a schematic illustrating a fourth display example of the boundary information;

FIG. 9 is a flowchart illustrating the sequence of a process in the testing system;

FIG. 10 is a schematic illustrating first test data, determination results, and result-unknown area;

FIG. 11 is a schematic illustrating the first test data, the determination results, and an intermediary area;

FIG. 12 is a schematic illustrating an example of test data and an inferred boundary;

FIG. 13 is a schematic illustrating a configuration of a testing system according to a modification;

FIG. 14 is a flowchart illustrating the sequence of a process in the testing system according to the modification;

FIG. 15 is a schematic illustrating an example of an inferred boundary and verification test data;

FIG. 16 is a schematic illustrating a configuration of a testing system according to a second embodiment;

FIG. 17 is a schematic illustrating a configuration of a testing system according to a third embodiment; and

FIG. 18 is a schematic illustrating a hardware configuration of an information processing apparatus according to the embodiments.

### DETAILED DESCRIPTION

According to one embodiment, an information processing apparatus includes a result acquiring unit and a generating unit. The result acquiring unit acquires a pair of first test data fed to a test object and a determination result indicating an operating state of the test object when the first test data is fed. The generating unit generates second test data based on the pair of the first test data and the determination result. The generating unit selects two pieces of the first test data with different determination results, and generates the second test data by generating test data with values falling within an intermediary area between the two selected pieces of the first test data more frequently than generating test data with values outside of the intermediary area.

A testing system according to some embodiments will now be explained in detail with reference to some drawings. The testing system according to the embodiments are aimed to enable boundary information representing the boundary between test data resulting in a failure and test data not resulting in a failure to be inferred accurately and efficiently.

### First Embodiment

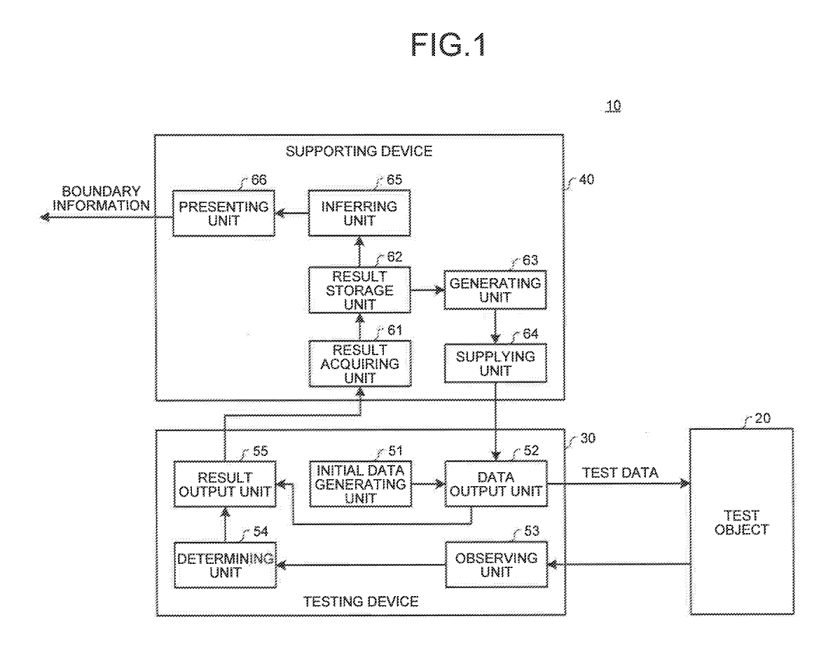

FIG. 1 is a schematic illustrating a configuration of a testing system 10 according to a first embodiment together with a test object 20. The testing system 10 includes a testing device 30 (first device), and a supporting device 40 (information processing apparatus) operating in coordination with the testing device (first device). The testing system 10 tests the test object 20.

The test object 20 is a device in which a computer program is incorporated, for example. The test object 20 may be a hardware device such as a semiconductor device. The test object 20 may also be a computer program executed by a computer. In the embodiment, the test object 20 is a piece of equipment in which a computer program is incorporated, and has a communicating function that uses communication protocols such as Internet Protocol version 4 (IPv4).

The testing device 30 tests the test object 20. More specifically, the testing device 30 determines an operating state of the test object 20 by feeding test data to the test object 20, and observing the operation of the test object 20 directly or indirectly. The operating state is usually represented as binary information taking either “pass” or “fail” representing whether the test object 20 is operating in accordance with a certain criterion. The criterion for “pass” of the operation varies depending on the configuration of the test object 20 and the specifics of the test. In the embodiment, the testing device 30 feeds IPv4 packets to the test object 20 to test the communicating function of the test object 20, as the test data.

In some cases, the operating state of the test object 20 cannot be represented as “pass” or “fail”. For example, when the test object 20 is temporarily disconnected from the testing system 10, the operation state of the test object 20 cannot be obtained, and thus may be classified into “unknown” or “inconclusive”. In that case, the operating state may be represented as ternary information or any other enumerable information.

The test data includes at least one parameter. The testing device 30 can cause the test object 20 to operate under a plurality of conditions by feeding a plurality of pieces of test data each of which has a different value assigned to the parameter to the test object 20. The testing device 30 then determines whether the test object 20 operates normally (“pass”) or does not operate normally (“fail”) under each of such conditions. When a piece of test data includes a plurality of parameters, the testing device 30 may change the values of some of the parameters, and keep the values of the others constant, for example. In this manner, the testing device 30 can easily identify the parameter that causes the test object 20 to operate abnormally when the value of such a parameter is changed.

The supporting device 40 supports the testing device 30. The supporting device 40 also serves to acquire a test history from the testing device 30, and to infer the boundary information based on the acquired test history. The supporting device 40 also generates, based on the test history of a first test, test data to be used by the testing device 30 in a second test. The supporting device 40 then supplies the generated test data to the testing device 30.

The testing device 30 and the supporting device 40 are connected to each other via a network, for example. The testing device 30 and the supporting device 40 may also be implemented in the same information processing apparatus, and may communicate with each other between their applications.

The testing device 30 includes an initial data generating unit 51, a data output unit 52, an observing unit 53, a determining unit 54, and a result output unit 55.

The initial data generating unit 51 generates a plurality of pieces of first test data that are to be fed to the test object 20 in the first test. The initial data generating unit 51 generates such pieces of first test data by changing the value of a target parameter in such a manner that the values become randomly distributed, using a technique called fuzzing, for example. Alternatively, a user may generate a plurality of pieces of first test data and store the pieces of first data in the initial data generating unit 51 before conducting the first test, for example, and the initial data generating unit 51 may feed the pieces of first test data stored therein in the first test. The initial data generating unit 51 may be included in the supporting device 40 or another device. In such a configuration, the testing device 30 acquires the pieces of first test data prior to the first test.

The data output unit 52 feeds test data to the test object 20. In the first test, the data output unit 52 acquires the first test data from the initial data generating unit 51, and feeds the first test data to the test object 20. In the second test, the data output unit 52 acquires the second test data from the supporting device 40, and feeds the second test data to the test object 20.

The data output unit 52 feeds the test data using different methods depending on the configuration of the test object 20 and the specifics of the test. For example, when tested is the communicating function of the test object 20, the data output unit 52 feeds the test data to the test object 20 over the network. When the test object 20 is a hardware device such as a semiconductor device, the data output unit 52 feeds the test data to a terminal of the test object 20. When the test object 20 is a computer program and running on the same information processing apparatus as the testing device 30, the data output unit 52 feeds the test data to the test object 20 using an inter-process communication, a shared memory, or any other communicating means. In the embodiment, the data output unit 52 feeds IPv4 packets to the test object 20 as test data over the network.

The observing unit 53 observes the operation of the test object 20. The observation herein is collecting information required to determine whether the test object 20 is operating in accordance with a certain criterion. The observation method, that is, the method with which the information is collected by the observing unit 53 varies depending on the configuration of the test object 20 and the specifics of the test.

For example, the observing unit 53 acquires response data or a response signal output from the test object 20 in response to a feed of test data, or at a point in time subsequent to the feed of the test data. The observing unit 53 acquires the response data via the same means as that via which the test data is acquired, for example. Specifically, when tested is the communicating function of the test object 20, the observing unit 53 acquires the response data from the test object 20 over the network.

When the test object 20 is a hardware device such as a semiconductor device, the observing unit 53 acquires a signal from a terminal of the test object 20. The signal may be an analog signal such as a voltage. In such a case, the observing unit 53 may convert the analog signal into a digital signal through analog-to-digital conversion.

When tested is the communicating function of the test object 20, to enable the observing unit 53 to acquire response data from the test object 20, the data output unit 52 may feed a piece of test data to the test object 20, and then feeds another piece of data that is different from such a piece of test data to the test object 20. For example, the data output unit 52 may send an Internet Control Message Protocol (ICMP) packet for checking the response to the test object 20 by executing a ping command, and the observing unit 53 may acquire response data responding thereto.

When the test object 20 is a piece of hardware equipment indicating an abnormal status by illuminating an error lamp, the observing unit 53 may acquire the illuminating status of the error lamp by capturing an image of the hardware equipment with a camera, for example.

When the test object 20 is a computer program running on the same information processing apparatus as the testing device 30, the observing unit 53 may acquire the response data from the test object 20 via an inter-process communication, a shared memory, or any other communicating means. The observing unit 53 may also use a software debugger to run the test object 20, and acquire information related to the internal operation of the test object 20 from the software debugger. In the embodiment, the observing unit 53 acquires IPv4 packets from the test object 20 as response data over the network. The observing unit 53 may acquire a plurality of types of information by combining any of these observation methods.

The determining unit 54 determines the operating state of the test object 20 when test data is fed, based on the observation result from the observing unit 53. For example, the determining unit 54 determines whether the operation of the test object 20 is good or no-good. The way in which the determining unit 54 makes such a determination varies depending on the configurations of the test object 20 and the observing unit 53, and the specifics of the test.

For example, when the observing unit 53 tests the communicating function of the test object 20, the determining unit 54 makes the determination based on whether the response data acquired by the observing unit 53 is received, that is, determines that the communicating function is operating normally (“pass”) when the response data is received, and determines that the communicating function is not operating normally (“fail”) when the response data is not received. The determining unit 54 may also determine that the test object 20 passes the test when the content of the response data is normal, and fails when the content of the response data is abnormal, based on the content of the response data.

As another example, when the test object 20 is a piece of hardware equipment regularly outputting a signal in accordance with some stipulation, and the observing unit 53 acquires the signal output from the test object 20, the determining unit 54 determines that the test object 20 has passed the test if the signals acquired through the observation by the observing unit 53 are as stipulated. If the observing unit 53 cannot acquire the signals, or if the acquired signals do not meet the stipulation, the determining unit 54 may determine that that the test object 20 has failed the test. As another example, when acquired by the observing unit 53 is the illumination status of the error lamp on the test object 20, the determining unit 54 may determine the test object 20 has passed the test if the error lamp is off, and determine that the test object 20 has failed the test if the error lamp is on.

As another example, when the test object 20 is a piece of software, the determining unit 54 may determine that the test object 20 has passed the test if the result data output in response to the test data matches the result data predicted based on the specifications, and determine that the test object 20 has failed the test when the test data does not match, or if the process is aborted. The determining unit 54 may also determine that the test object 20 has passed the test if the normal internal status is observed by a debugger, and determine that the test object 20 has failed the test if some abnormal status is observed by the debugger. The determining unit 54 may also determine the operating state by combining any of these determination ways.

The result output unit 55 transmits the pair of the test data fed to the test object 20 by the data output unit 52 and the determination result of the determining unit 54 to the supporting device 40, as a test history. In the first test, the result output unit 55 transmits the pair of the first test data fed into the test object 20 and the corresponding determination result to the supporting device 40. In the second test, the result output unit 55 transmits the pair of the second test data and the corresponding determination result to the supporting device 40.

The supporting device 40 includes a result acquiring unit 61, a result storage unit 62, a generating unit 63, a supplying unit 64, an inferring unit 65, and a presenting unit 66.

The result acquiring unit 61 acquires the test history from the testing device 30. More specifically, in the first test, the result acquiring unit 61 acquires pairs of the pieces of first test data fed to the test object 20 by the testing device 30, and the respective determination results indicating the operating state of the test object 20 when the respective pieces of first test data are fed. In the second test, the result acquiring unit 61 acquires the pair of the second test data fed to the test object 20 by the testing device 30, and the determination result indicating the operating state of the test object 20 when the second test data is fed.

The result storage unit 62 stores therein the test history acquired by the result acquiring unit 61. Specifically, the result storage unit 62 stores therein the pairs of pieces of the first test data and the corresponding determination results. The result storage unit 62 also stores therein the pair of the second test data and the corresponding determination result. The result storage unit 62 may be any kind of storage unit such as a database, a file system, and a main memory.

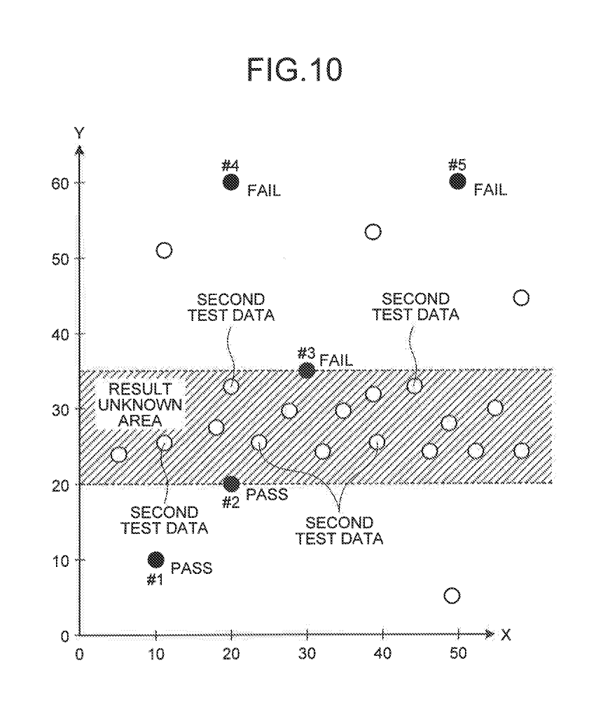

The generating unit 63 generates the second test data for enabling the testing device 30 to test the test object 20 after the first test, but before the second test, based on the pairs of the first test data and the corresponding determination result. The generating unit 63 generates the second test data in which any one of the parameters takes a value in a result-unknown area that is defined by the pieces of first test data and the determination results. A specific example of the way in which the generating unit 63 generates the second test data will be further explained with reference to FIG. 10 and thereafter.

The supplying unit 64 supplies the generated second test data to the testing device 30 before the second test. The inferring unit 65 infers the boundary information that represents the threshold of the parameter at which the determination result becomes switched, and the determination results belonging to areas separated by the threshold, based on the test history stored in the result storage unit 62. The presenting unit 66 presents the boundary information inferred by the inferring unit 65 to users.

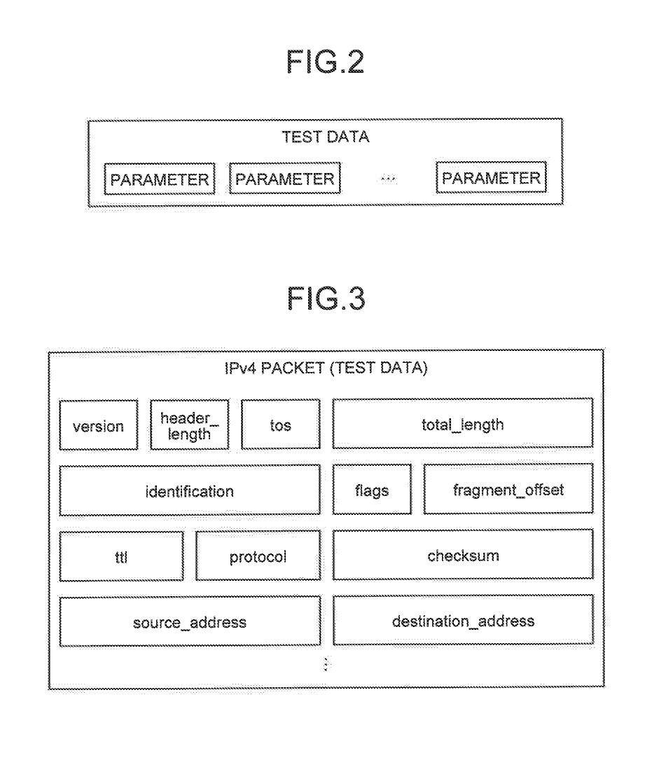

FIG. 2 is a schematic illustrating a configuration of the test data. The test data includes at least one parameter, as illustrated in FIG. 2. The testing device 30 feeds a plurality of pieces of test data each of which has a different value assigned to the parameter in the test data to the test object 20, and determines whether the test object 20 operates normally or does not operate normally. When the test data includes a plurality of parameters, the testing device 30 may change the values in some of the parameters, while keeping the values in the others constant.

FIG. 3 is a schematic illustrating a configuration of an IPv4 packet. In the embodiment, the testing device 30 transmits IPv4 packets to the test object 20 as the test data. The IPv4 packet includes version, header_length, tos, total_length, identification, flags, fragment_offset, ttl, protocol, checksum, source_address, and destination_address, for example, as its parameters.

In the first test, the testing device 30 outputs a plurality of pieces of test data (IPv4 packets) by combining the values of these parameters randomly. Alternatively, the testing device 30 may change the values of some of these parameters randomly, while keeping the values of the other parameters constant in the IPv4 packets to be output.

These parameters may also have values outside of the range that the test object 20 receives in ordinary communications. In this manner, the testing device 30 can determine whether the test object 20 does not fall into an abnormal operation, for example, when the test object 20 receives the parameters with values outside of the range normally received in ordinary communications.

The test data may be any data without limitation to such packets. For example, when the test object 20 is a piece of equipment or software for processing image data, the test data will be information including image data.

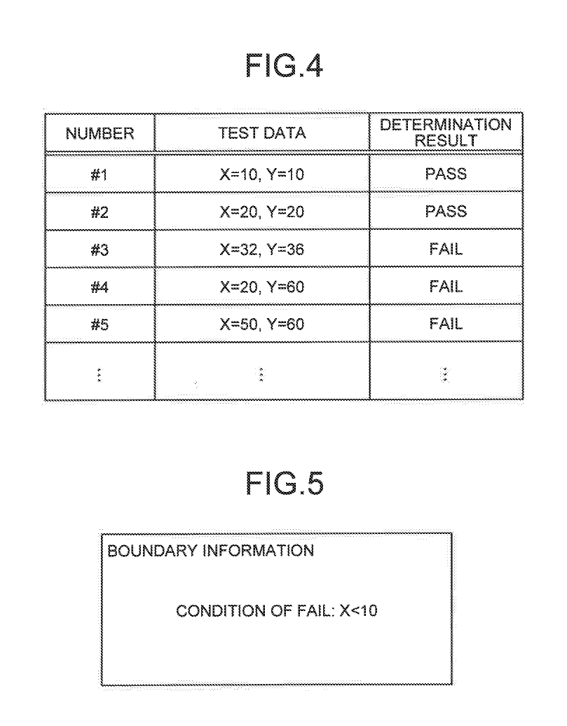

FIG. 4 is a schematic illustrating an example of the test history. The result acquiring unit 61 acquires the test history from the testing device 30, and stores the test history in the result storage unit 62.

The result storage unit 62 stores therein pieces of test data in association with the respective determination results representing the operating state of the test object 20 in response to a feed of the test data. The determination results represent either “pass” or “fail”. The “pass” is a determination result representing that the test object 20 has operated normally in response to a feed of the test data. The “fail” is a determination result representing that the test object 20 has not operated normally in response to a feed of the test data.

The determination result may also represent skip and the like, for example. Skip is a determination result representing that the test data could not be output due to some cause on the side of the testing device 30, for example. The determination result may also represent pass quality or a pass level of the test object 20.

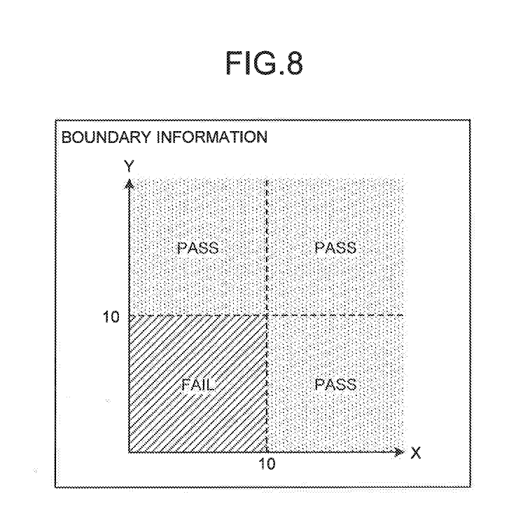

FIGS. 5, 6, 7, and 8 are schematics illustrating examples of how boundary information is displayed. The inferring unit 65 infers the boundary information. The presenting unit 66 presents the boundary information inferred by the inferring unit 65 to users. The boundary information represents the threshold of the parameter value at which the determination result becomes switched, and the determination results belonging to the areas that is separated by the threshold.

For example, it is assumed herein that the determination result is switched between “pass” and “fail” when the values of some of the parameters included in test data are changed while keeping the values of the others constant. In such a case, the threshold represented in the boundary information is the values of some of the parameters at which the determination result is switched between “pass” and “fail”. The determination results included in the areas represented in the boundary information serves as information indicating whether the values greater than threshold (or values equal to or greater than the threshold) resulted in “pass” or “fail”, or the values less than the threshold (or values equal to or smaller than the threshold) resulted in “pass” or “fail”.

The presenting unit 66 presents users with the boundary information expressed as an inequality, or as a graph.

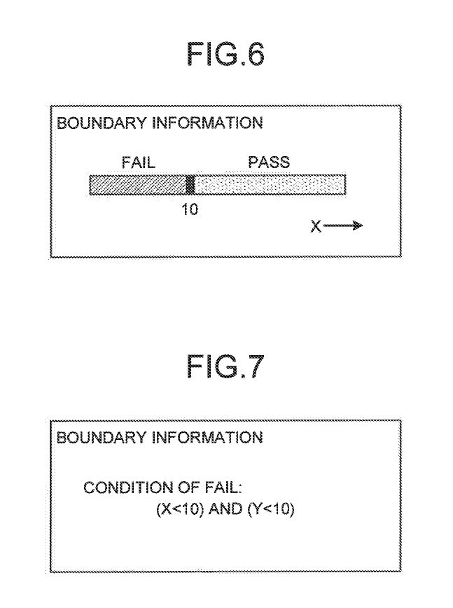

For example, when the boundary information represents “fail” for a parameter X less than 10, and “pass” for the parameter X equal to or greater than 10, the presenting unit 66 may present users with an inequality indicating that the condition of “fail” is “X<10”, as illustrated in FIG. 5, as the boundary information. Alternatively, when the boundary information represents “fail” for the parameter X less than 10, and “pass” for the parameter X equal to or greater than 10, the presenting unit 66 may display a one-dimensional graph as the boundary information, as illustrated in FIG. 6. In other words, the presenting unit 66 may display the one-dimensional graph indicating the position of the threshold on the X axis, and indicating the “pass” area and the “fail” area on the X axis.

For example, when the boundary information represents “fail” for the parameter X less than 10 and for a parameter Y less than 10, and represents “pass” for any other values, the presenting unit 66 may present logical expressions indicating that the conditions for “fail” are “X<10” AND “Y<10”, as illustrated in FIG. 7, as the boundary information. When the boundary information represents “fail” for the parameter X less than 10 and the parameter Y less than 10, and represents “pass” with any other values, the presenting unit 66 may display a two-dimensional graph as illustrated in FIG. 3 as the boundary information. In other words, the presenting unit 66 may display the position of the threshold on the X axis and Y axis, respectively, and a two-dimensional graph indicating a “pass” area and a “fail” area in the space defined by the X axis and the Y axis.

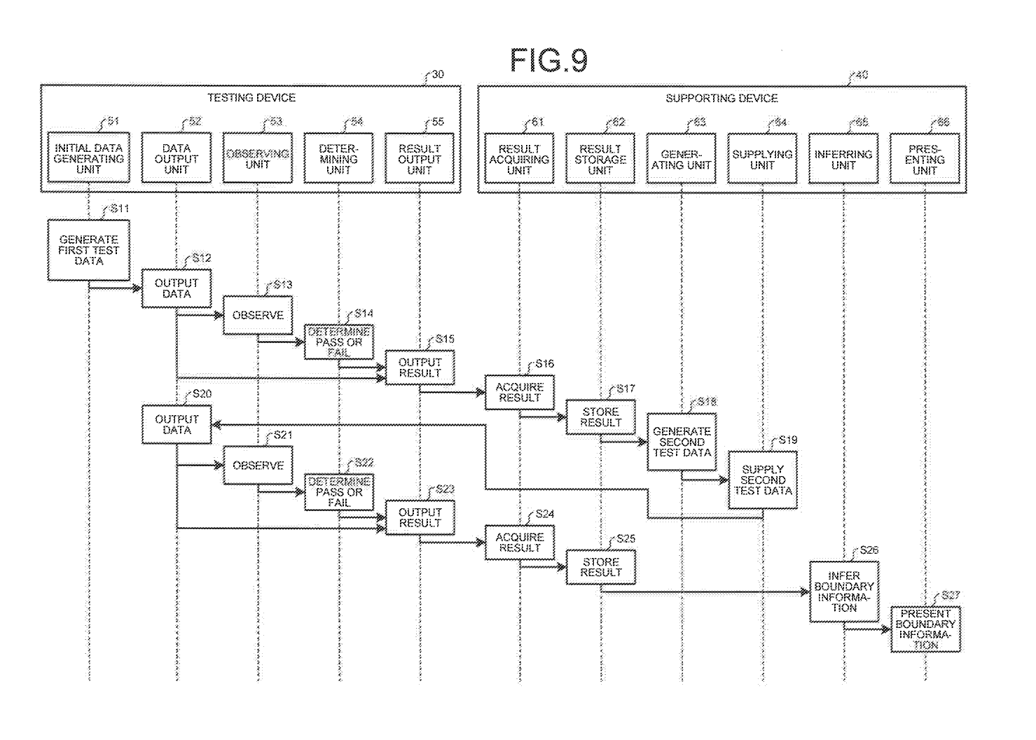

FIG. 9 is a flowchart illustrating the sequence of a process in the testing system 10. To begin with, at Step S11, the initial data generating unit 51 generates a plurality of pieces of first test data. As an example, the initial data generating unit 51 generates a plurality of pieces of first test data having at least some of the parameters changing randomly.

At Step S12, the data output unit 52 feeds the pieces of first test data one after another to the test object 20. At Step S13, the observing unit 53 observes the test object 20.

At Step S14, the determining unit 54 determines the operating state of the test object 20 based on the observation result from the observing unit 53 when the first test data is fed from the data output unit 52. At Step S15, the result output unit 55 transmits the pairs of the first test data and the corresponding determination result to the supporting device 40.

At Step S16, the result acquiring unit 61 receives the pairs of the first test data and the corresponding determination result from the testing device 30. At Step S17, the result storage unit 62 stores therein the pairs of the first test data and the corresponding determination result acquired by the result acquiring unit 61.

At Step S18, the generating unit 63 generates the second test data for enabling the testing device 30 to test the test object 20, based on the pairs of the first test data and the corresponding determination result stored in the result storage unit 62. A specific example of the way in which the generating unit 63 generates the second test data will be explained further with reference to FIG. 10 and thereafter. At Step S19, the supplying unit 64 supplies the second test data generated by the generating unit 63 to the testing device 30.

At Step S20, the data output unit 52 feeds the second test data to the test object 20. At Step S21, the observing unit 53 observes the test object 20.

At Step S22, the determining unit 54 determines the operating state of the test object 20 when the corresponding second test data is fed, based on the observation result from the observing unit 53. At Step S23, the result output unit 55 transmits the pair of the second test data and the determination result to the supporting device 40.

At Step S24, the result acquiring unit 61 receives the pair of the second test data and the determination result from the testing device 30. At Step S25, the result storage unit 62 stores the pair of the second test data and the determination result acquired by the result acquiring unit 61, in addition to the pairs of the first test data and the corresponding determination result currently stored.

At Step S26, the inferring unit 65 infers the boundary information based on the pairs of the test data and the corresponding determination result stored in the result storage unit 62 (the pairs of the first test data and the corresponding determination result, and the pair of the second test data and the determination result). At Step S27, the presenting unit 66 presents the boundary information inferred by the inferring unit 65 to the user.

FIG. 10 is a schematic illustrating the pieces of first test data and the determination results in the test history illustrated in FIG. 4, a result-unknown area, and the generated second test data.

The generating unit 63 generates the second test data for the testing device 30 to test the test object 20, based on the pieces of first test data and the respective determination results stored in the result storage unit 62. In this process, the generating unit 63 generates the second test data in such a manner that pieces of test data having all of its parameters with values falling within the result-unknown area positioning between the pieces of first test data resulting in different determination results are more frequently generated than the generation of pieces of test data with values in the range outside the result-unknown area.

Generally, when the test object 20 is fed with a plurality of pieces of first test data including parameters taking randomly distributed values, the space defined by axes corresponding to the values of the respective parameters is divided into area including the first data resulting in “pass”, an area including the first test data resulting in “fail”, and the other area. For example, the test object 20 is fed with a plurality of pieces of first test data including the parameter X and the parameter Y taking randomly distributed values, the plane defined by the X axis and the Y axis is divided into an inferred area “pass” and another inferred area “fail”. In the example illustrated in FIG. 10, the area including the number #1 test data (X=10, Y=10) and the number #2 test data (X=20, Y=20) is the “pass” inferred area, and the area including the number #3 test data (X=32, Y=36), the number #4 test data (X=20, Y=60), and the number #5 test data (X=50, Y=60) is the “fail” inferred area.

When a plurality of pieces of first test data including parameters taking randomly distributed values are fed to the test object 20, the space defined by the axes representing the values of the respective parameters also includes an area for which it is unknown as to whether the result is “pass” or “fail”, and which positions between the area corresponding to “pass” and the area corresponding to “fail”. In the embodiment, this area is referred to as a result-unknown area.

It can be inferred that the boundary separating the actual “pass” area from the actual “fail” area is included in the result-unknown area. The generating unit 63 therefore generates the second test data in such a manner that pieces of test data having all of its parameters with values falling within the area of the result-unknown area positioning between the “pass” area and the “fail” area separated from each other are more frequent than pieces of test data with values falling outside of the result-unknown area. The test data being more frequent means that the interval between the parameter values in the test data is smaller than those between the parameter values in the others. To describe intuitively, representing pieces of test data as points plotted on a plane defined by two parameters, as in the example in FIG. 10, the test data being more frequent means that a larger number of points, representing pieces of test data, are plotted to the same unit area. When generated is only the pieces of test data with values falling within this area, without generating any piece of test data with values falling outside of the area, the pieces of test data falling within the area are also considered more frequent than the test data falling outside of the area.

In the example in FIG. 10, the area positioning between the number #2 (“pass”) and the number #3 (“fail”) can be considered as the result-unknown area. Therefore, in the example in FIG. 10, the generating unit 63 generates the second test data in such a manner that the pieces of test data having all of its parameters with values falling within the result-unknown area extending between the number #2 (“pass”) and the number #3 (“fail”) are more frequent than pieces of test data with those assigned with values in the range outside of the result-unknown area. In this manner, the generating unit 63 can generate the second test data enabling the position of the boundary between the actual “pass” and “fail” to be inferred more accurately.

The generating unit 63 may generate one piece of second test data, or generate a plurality of pieces of second test data. When the generating unit 63 generates a plurality of pieces of second test data, the generating unit 63 may generate the second test data in such a manner that the second test data is more frequent than the first test data. In this manner, the generating unit 63 can generate second test data allowing the position of the boundary between “pass” and “fail” to be inferred more accurately.

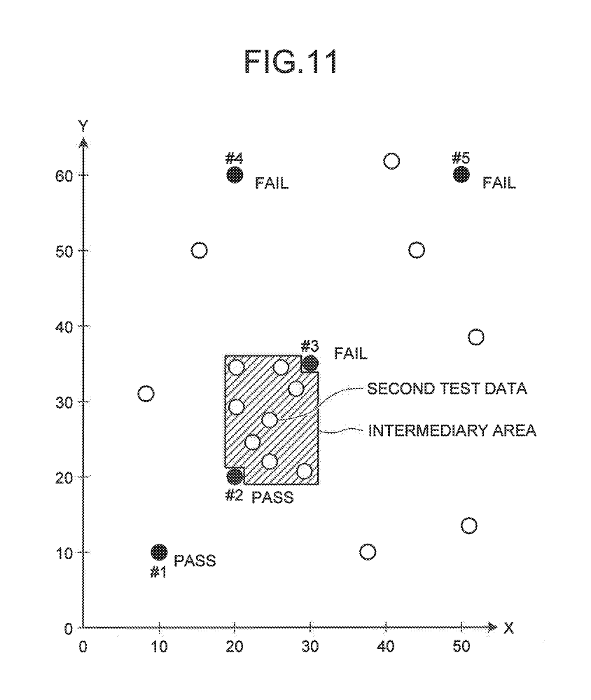

FIG. 11 is a schematic illustrating the first test data and the determination results in the test history illustrated in FIG. 4, an intermediary area, and the generated second test data. To generate the second test data, the generating unit 63 executes a process explained below, for example.

The generating unit 63 selects two pieces of first test data with different determination results. In other words, the generating unit 63 selects a piece of first test data with the determination result “pass”, and another piece of first test data with the determination result “fail”. The generating unit 63 may generate the second test data by generating pieces of test data with parameter values falling within the intermediary area between the two selected pieces of first test data more frequently. In this manner, the generating unit 63 can generate the second test data enabling the position of the boundary between “pass” and “fail” to be inferred more accurately.

The intermediary area between two pieces of test data A and B is defined as below. The intermediary area between the two pieces of test data A and B is an area in which a set of pieces of test data are included. Each piece of test data P belonging to the set of pieces of test data within the intermediary area has a parameter value p that falls within a closed interval [a, b] between the smaller one and the larger one of the two values “a” and “b” assigned to the two pieces of test data A and B, respectively. The two pieces of test data A and B are not included in the set of pieces of test data within the intermediary area.

In other words, using the intentional definition of a set, the intermediary area R between A=(a₁, . . . , aₙ) and B=(b₁, . . . , bₙ) can be defined as:

R:={(p₁, . . . ,pₙ)|∀i·p₁ε[aᵢ,bᵢ]}\{A and B},

where “n” denotes the number of parameters, that is, the dimension of the parameter space, and “\” denotes a difference set operation.

For example, when the test data has two parameters, in other words, the parameter space is two dimensional, the intermediary area represents a set of pieces of test data in which every piece P=(pₓ, p_{y}) has a first parameter pₓ assigned with a value between the first parameter value aₓ and the first parameter value bₓ of the two selected pieces of first test data A=(aₓ, a_{y}) and B=(bᵣ, b_{y}), and has a second parameter p_{y} assigned with a value between the second parameter values a_{y} and b_{y} of the two selected pieces of first test data A and B. In other words, in the two dimensional parameter space illustrated in FIG. 11, that is, in the coordinate plane in which the two parameters of the test data are plotted on the X axis and the Y axis, respectively, the intermediary area is represented as an area corresponding to a rectangle having its vertexes at two facing corners corresponding to the two selected pieces of first test data, but as the area excluding the two pieces of first test data from the internal area of the rectangle. When one of the parameters included in each of the two selected pieces of first test data has the same value, the intermediary area is represented as a segment (but not including the end points) connecting the two selected pieces of first test data. When there are three designated parameters, the intermediary area is represented as, in a coordinate space with the three designated parameters plotted on the X axis, the Y axis, and the Z axis, respectively, a cuboid with its vertexes at two facing corners corresponding to the two selected pieces of first test data, and the cuboid excluding the two pieces of first test data from the boundary and the internal of the cuboid.

The generating unit 63 may select the two pieces of first test data in such a manner that there is no any other piece of the first test data in the intermediary area. For example, in the example illustrated in FIG. 11, the parameters X and Y are designated. In such a case, the number #2 first test data (X=20, Y=20) is within the intermediary area defined by the number #1 first test data (X=10, Y=10) and the number #3 first test data (X=32, Y=36). Therefore, the generating unit 63 does not select the pair of the number #1 first test data and the number #3 first test data. By contrast, there is no any other piece of the first test data in the intermediary area defined by the number #2 first test data (X=20, Y=20) and the number #3 first test data (X=32, Y=36). Therefore, the generating unit 63 selects the pair of the number #2 first test data and the number #3 first test data.

In this manner, by selecting two pieces of first test data with different determination results in such a manner that there is no any other piece of the first test data in the intermediary area defined thereby, the generating unit 63 can generate the second test data having its parameter with a value falling within an area that is highly likely to include the boundary.

The generating unit 63 may also select two pieces of first test data having different determination results, and including parameter values nearest to each other. As an example, the generating unit 63 calculates the distance for each of two pieces of first test data with different determination results, and selects two pieces of first test data having the shortest distance.

The distance may be, for example, a Euclidean distance. In the example in FIG. 11, the two pieces of first test data having different determination results and the shortest Euclidean distance is the pair of the number #2 first test data (X=20, Y=20) and the number #3 first test data (X=32, Y=36). Therefore, the generating unit 63 selects the pair of the number #2 first test data and the number #3 first test data. The generating unit 63 may also select the two pieces of first test data with the shortest Manhattan or Mahalanobis' distance, without limitation to the Euclidean distance.

By selecting the two pieces of first test data with different determination results and with the shortest distance in the manner described above, the generating unit 63 can generate the second test data in an area that is highly likely to include the boundary.

The generating unit 63 may also select the two pieces of first test data with different determination results and including a largest number of parameters sharing the same values. For example, in the example in FIG. 11, the number #2 first test data (X=20, Y=20) and the number #4 first test data (X=20, Y=60) share the same value in the parameter X. Therefore, in this case, the generating unit 63 selects the pair of the number #2 first test data and the number #4 first test data. In this manner, the generating unit 63 can select two pieces of first test data that are similar to each other, but result in different determination results.

The generating unit 63 may use any other method, without limitation to those described above, to select the two pieces of first test data from the pieces of first test data.

The generating unit 63 may generate two pieces of second test data by swapping the values of some parameter in the two selected pieces of first test data. In this manner, the generating unit 63 can generate the second test data easily. For example, assuming that the number #2 first test data (X=20, Y=20) and the number #3 first test data (X=32, Y=36) are selected in the example in FIG. 11, the generating unit 63 generates the two pieces of second test data (X=20, Y=36) and (X=32, Y=20) by swapping the values of the parameter Y.

The generating unit 63 may also generate one piece of second test data with a parameter assigned with an average of the values of the corresponding parameters in the two pieces of first test data selected by any one of the method described above. In this manner, the generating unit 63 can generate the second test data permitting the boundary between “pass” and “fail” to be inferred efficiently.

For example, when the number #2 first test data (X=20, Y=20) and the number #3 first test data (X=32, Y=36) are selected in the example illustrated in FIG. 11, the average of the values of the parameter X is 26, and the average of the values of the parameter Y is 28. Therefore, in this example, the generating unit 63 generates one piece of second test data (X=26, Y=28). When this method is used, the generating unit 63 can generate the second test data even when some of the parameters have the same value.

The generating unit 63 may generate at least one piece of second test data from two pieces of first test data using any other method, without limitation to the method described above.

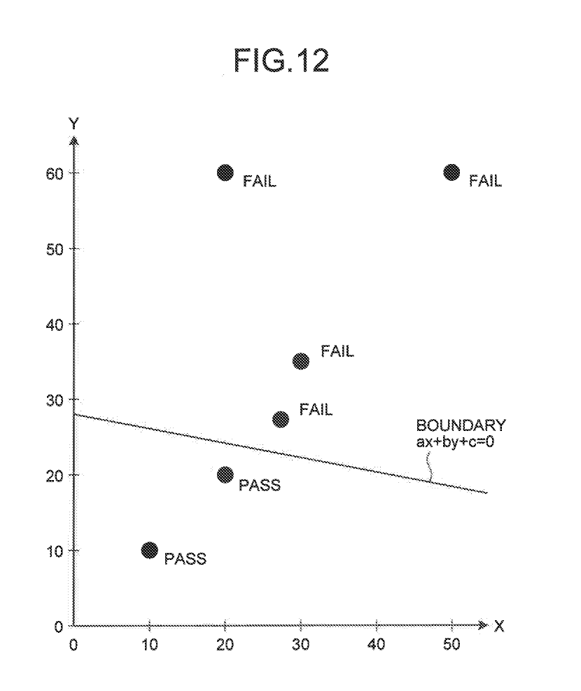

FIG. 12 is a schematic illustrating an example of the test data, the determination results, and the inferred boundary. Upon completion of the first test and the second test, the inferring unit 65 infers the boundary information based on the test history stored in the result storage unit 62. The inferring unit 65 infers the boundary information using a statistical classification technique, for example.

The inferring unit 65 may use a support vector machine as a statistical classification technique. The support vector machine is a technique that linearly separates a plurality of pieces of data classified into two classes, based on such pieces of data. Specifically, the support vector machine represents a plurality of pieces of data that are classified into two classes as points, and draws a line that classifies the class. The support vector machine then calculates a line in such a manner that the distance (margin) between two points in the respective classes is maximized.

For example, when the data to be classified is the test data including two parameters X and Y illustrated in FIG. 12, the inferring unit 65, to begin with, generates a line aX+bY+c=0 separating the “pass” area and the “fail” area. The inferring unit 65 then calculates constants a, b, and c maximizing a minimal value of the distance between two pieces of test data (points) belonging to the respective classes. In this manner, the inferring unit 65 can infer the boundary information representing the parameter threshold at which the determination result is switched, and the determination results that belong to these areas separated by the threshold.

The inferring unit 65 may also infer the boundary information using any other methods. For example, the inferring unit 65 may infer the boundary information using statistical techniques such as neural network and decision tree learning and the like.

Modification

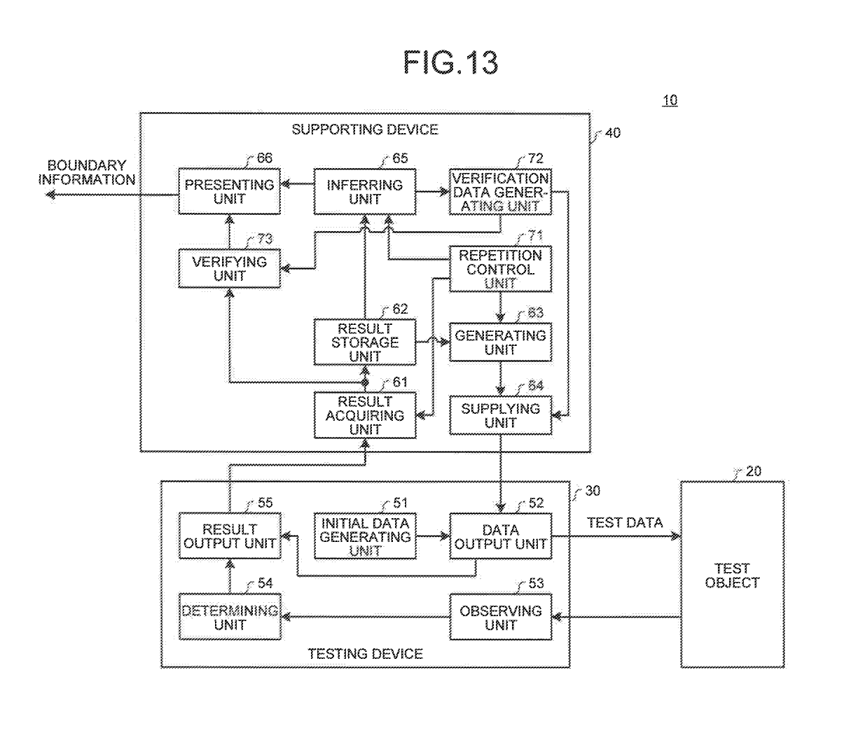

FIG. 13 is a schematic illustrating a configuration of the testing system 10 according to a modification of the first embodiment. Because the testing system 10 according to the present modification substantially has the same configuration as that illustrated in FIG. 1, the members with substantially the same function and configuration are given the same reference numerals, and detailed explanations thereof are omitted, except for their differences.

The testing device 30 according to the present modification repeats the test of the test object 20 three times or more. The supporting device 40 generates the second test data for the second test and thereafter, based on the test history acquired from the immediately previous test, and feeds the second test data to the testing device 30.

The supporting device 40 further includes a repetition control unit 71, a verification data generating unit 72, and a verifying unit 73, in addition to the units illustrated in FIG. 1.

The repetition control unit 71 controls these units to generate the second test data to be used in the second test and thereafter. More specifically, the repetition control unit 71 causes the result acquiring unit 61 to acquire, as a pair, the second test data fed to the test object by the testing device 30 and the determination result indicating the operating state of the test object 20 when the second test data is fed. The repetition control unit 71 then causes the result storage unit 62 to add and to store therein the acquired pair of the second test data and the determination result, and synthesizes the added pair of the second test and the determination result, with the pairs of the first test data and the determination result having been already stored. The synthesized pair of the second test data and the determination result is then handled as a pair of the first test data and the determination result.

The repetition control unit 71 then causes the generating unit 63 to generate a new piece of second test data based on the pairs of the first test data and the corresponding determination result stored in the result storage unit 62. The repetition control unit 71 then repeats the process described above until a predetermined condition is satisfied.

When such repetition control of the repetition control unit 71 is ended, the inferring unit 65 infers the boundary information based on the pairs of the test data and the corresponding determination result stored in the result storage unit 62. The verification data generating unit 72 then generates verification test data including a parameter assigned with values in the respective areas separated by the threshold, based on the boundary information inferred by the inferring unit 65. The verification data generating unit 72 then generates prediction information for predicting the operating state of the test object 20 when the verification test data is fed, based on the relation between the boundary information and the verification test data. The verification data generating unit 72 then feeds the prediction information to the verifying unit 73.

When the verification data generating unit 72 has generated the verification test data, the supplying unit 64 supplies the verification test data to the testing device 30. When the verification test data is received from the supporting device 40, the data output unit 52 feeds the verification test data to the test object 20. The observing unit 53 then observes the test object 20. The determining unit 54 then determines the operating state of the test object 20 when the verification test data is fed. The result output unit 55 then transmits the verification test data fed to the test object 20 by the data output unit 52, and the determination result of the determining unit 54, as a pair, to the supporting device 40. The result acquiring unit 61 receives the pair of the verification test data and the determination result indicating the operating state of the test object 20 when the verification test data is fed from the testing device 30.

The verifying unit 73 acquires the determination result indicating the operating state of the test object 20 when the verification test data is fed. The verifying unit 73 also acquires the prediction information predicting the operating state of the test object 20 when the verification test data is fed from the verification data generating unit 72. The verifying unit 73 then verifies whether the determination result and the prediction information match, and, if the determination result and the prediction information match, outputs the boundary information to the presenting unit 66.

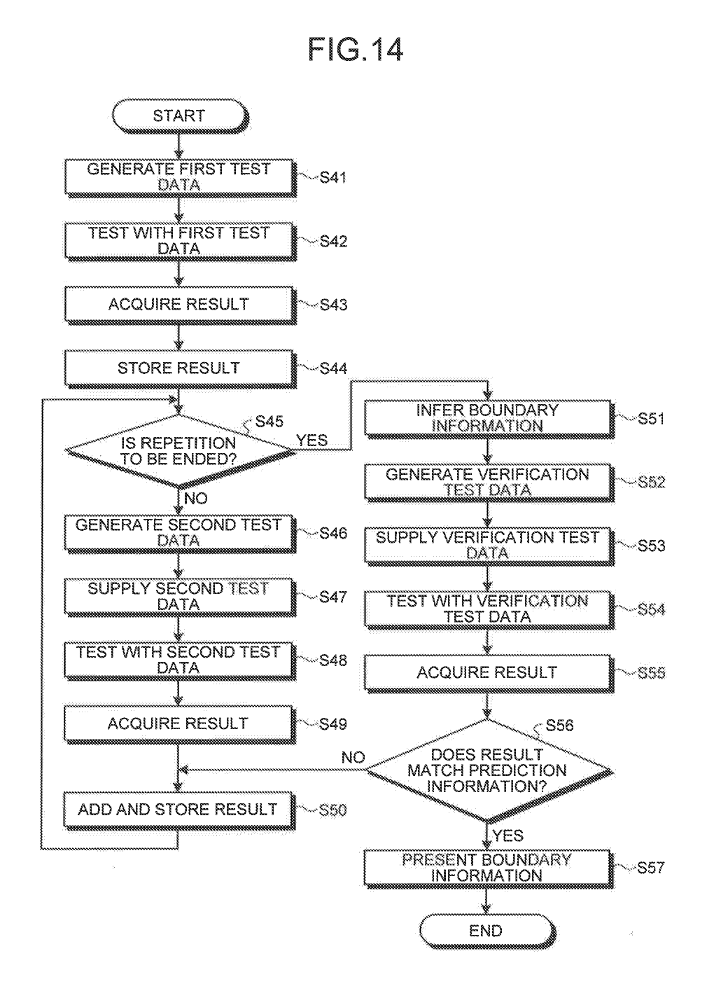

FIG. 14 is a flowchart illustrating the sequence of a process in the testing system 10 according to the modification. To begin with, at Step S41, the initial data present generating unit 51 generates a plurality of pieces of first test data.

At Step S42, the testing device 30 feeds the pieces of first test data one after another to the test object 20, and acquires the respective pieces of response data one after another. The testing device 30 then determines the operating state of the test object 20 based on each of the acquired pieces of response data, and transmits the pairs of the first test data and the corresponding determination result to the supporting device 40.

At Step S43, the result acquiring unit 61 then acquires pairs of the first test data and the corresponding determination result from the testing device 30. At Step S44, the result storage unit 62 then stores therein the pairs of the first test data and the corresponding determination result acquired by the result acquiring unit 61.

At Step S45, the repetition control unit 71 determines whether to end the repetition of the process. If the repetition of the process is not to be ended (No at 345), the repetition control unit 71 shifts the process to Step S46. If the repetition of the process is to be ended (Yes at S45), the repetition control unit 71 shifts the process to Step S51.

If the repetition of the process is not to be ended (No at S45), at Step S46, the generating unit 63 generates the second test data for enabling the testing device 30 to test the test object 20, based on the pairs of the first test data and the corresponding determination result stored in the result storage unit 62. At Step S47, the supplying unit 64 supplies the second test data generated by the generating unit 63 to the testing device 30.

At Step S48, the testing device 30 feeds the second test data to the test object 20, and acquires the response data. The testing device 30 determines the operating state of the test object 20 based on the acquired response data, and transmits the pairs of the second test data and the determination result to the supporting device 40.

At Step S49, the result acquiring unit 61 then acquires the pair of the second test data and the determination result from the testing device 30. At Step S50, the result storage unit 62 adds and stores the pairs of the second test data and the determination result acquired by the result acquiring unit 61, as a new pair of the first test data and the determination result. This enables the result storage unit 62 to synthesize the acquired pair of the second test data and the determination result with the pair of the first test data and the determination result having been already stored.

Upon completion of Step S50, the repetition control unit 71 shifts the process back to Step S45, and determines whether to end the repetition of the process, again.

At Step S45, if sufficient results for inferring the boundary information have been acquired, the repetition control unit 71 ends the repetition. For example, the repetition control unit 71 selects two nearest pieces of first test data having different determination results. The repetition control unit 71 then determines whether there is any margin for generating a new piece of second test data in the area extending between the two nearest pieces of first test data. In other words, the repetition control unit 71 determines whether the values of the parameter in the respective two nearest pieces of first test data are adjacent to each other. If the values of the parameter are adjacent to each other, there is no margin for generating a new piece of second test data in the area extending between the two pieces of first test data. By contrast, if the values of the parameter are not adjacent to each other, there is a margin for generating a new piece of second test data in the area extending between the two pieces of first test data. If there is any margin for generating a new piece of second test data, the repetition control unit 71 continues the repetition. If there is no margin for generating a new piece of second test data, the repetition control unit 71 determines that the sufficient results for inferring the boundary information has been acquired, and ends the repetition.

Without limitation to such a method, the repetition control unit 71 may determine whether to end the repetition of the process using any other methods. As an example, the repetition control unit 71 may end the repetition when the repetition has been continued for a certain number of times or a certain length of time.

If the repetition of the process is to be ended (Yes at S45), at Step S51, the inferring unit 65 infers the boundary information based on the pairs of the test data and the corresponding determination result stored in the result storage unit 62. At Step S52, the verification data generating unit 72 generates the verification test data including the parameters assigned with values belonging to the respective areas that are separated by the threshold, based on the boundary information. At Step S353, the supplying unit 64 supplies the verification test data to the testing device 30.

At Step S54, the testing device 30 feeds the verification test data to the test object 20, and acquires the response data. The testing device 30 then determines the operating state of the test object 20 based on the acquired response data, and transmits the pair of the verification test data and the determination result to the supporting device 40.

At Step S55, the result acquiring unit 61 acquires the pair of the verification test data and the determination result from the testing device 30. At Step S56, the verifying unit 73 verifies whether the determination result indicating the operating state of the test object 20 when the verification test data is fed, matches the prediction information. If the determination result does not match the prediction information (No at S56), the verifying unit 73 shifts the process back to Step S50. Once the process is returned, the result storage unit 62 adds and stores the pair of the verification test data and the determination result acquired by the result acquiring unit 61 as a pair of the first test data and the determination result.

If the determination result matches the prediction information (Yes at S56), the verifying unit 73 shifts the process to Step S57. At Step S57, the presenting unit 66 presents the boundary information inferred by the inferring unit 65 to the user.

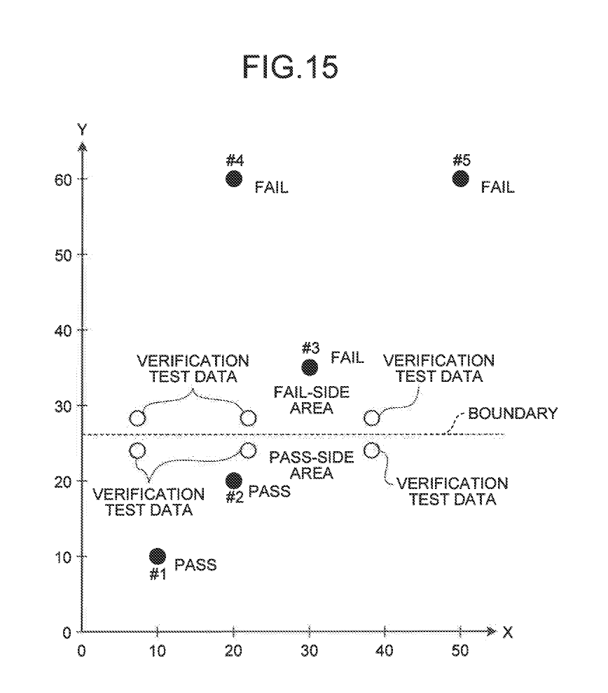

FIG. 15 is a schematic illustrating an example of the inferred boundary information and the verification test data. The verification data generating unit 72 generates pieces of verification test data with parameter values belonging to the “pass”-side area and the “fail”-side area, respectively, near the boundary represented by the boundary information. For example, the verification data generating unit 72 generates a plurality of pairs of verification test data with parameter values belonging to the “pass”-side area and the test data with those belonging to the “fail”-side area.

In this situation, the verification data generating unit 72 may use adjacent values for a parameter included in a pair of verification test data belonging to the “pass”-side area and another piece of verification test data belonging to the “fail”-side area, respectively. For example, if the condition for “fail” is the value of the parameter Y being greater than 35 (Y>35), the verification data generating unit 72 generates a plurality of pairs of verification test data with the parameter Y=36 and verification test data with the parameter Y=35, while changing the value of the other parameter X. The verification data generating unit 72 may use values that are separated by a certain value with respect to the boundary therebetween, without limitation to the adjacent values. In this manner, the verification data generating unit 72 can generate verification test data enabled to verify the inference information accurately.

### Advantageous Effects

As described above, the testing system 10 according to the embodiment tests the test object 20 using the first test data, and generates the second test data based on a pair of the first test data and the corresponding determination result. In this case, the testing system 10 generates the second test data in such a manner that the pieces of test data having any one of the parameters is assigned with a value falling within the result-unknown area positioning between a plurality of pieces of first test data resulting in different determination results. The testing system 10 then tests the test object 20 with the second test data, and infers the boundary information based on the determination result from the first test data and the determination result from the second test data.

With the testing system 10 according to the embodiment, the boundary information can be inferred more accurately, compared with when the boundary information is inferred by running the test only one time. Furthermore, with the testing system 10 according to the embodiment, the precision that can be acquired by feeding a large amount of test data can be acquired with a smaller number of pieces of test data.

For example, let us herein assume that the test data includes two parameters of “type” and “length”, and that the test object 20 falls into an abnormal operation due to buffer overflow, when the “length” exceeds 10.

In this example, the developer can only acquire one determination result. Therefore, the developer is only given the fact that when “{type=7, length=20}, a failure occurred”. However, the developer cannot identify the value of which parameters of “type” or “length” is problematic. Furthermore, the developer cannot identify which range of such a parameter is problematic, assuming that there is a problem in the parameter. If the developer cannot identify such a problem, the developer will face a difficulty in predicting the cause of the failure in the test object 20.

By contrast, if developer can acquire the boundary information that “the failure occurred when the “length” is too large”, the developer can predict that the cause of the failure is quite likely to be the buffer overflow. Furthermore, if the developer can acquire the boundary information that “a failure occurred when the “length” exceeds 10”, the developer can examine the portion of the computer program at which the memory is reserved with a constant “10”, or at which a comparison with a constant “10” is performed, for example, around the portion where the “length” is used. In this manner, the developer can find and correct the defect of the test object 20 directly. By allowing a specific cause and condition to be inferred from the determination results in the manner described above, the developer can find and correct the portion corresponding to the defect in the test object 20.

To infer mechanically specific boundary information from the determination result, a technique of calculating a correlation between the test data and the determination result with statistical data processing has been used. However, from the test data and the determination result acquired from a single test, it is quite likely that the boundary information cannot be inferred accurately. For example, when a determination result indicating that no failure has occurred with {type=7, length=5}, and a failure has occurred with {type=7, length=30} is acquired, it is often difficult to identify the threshold at which a failure occurs, e.g., at a length >10 or a length >20. To prevent this problem, it is necessary to execute the test by feeding a large number of pieces of test data with different values given to a large number of parameters to the test object 20 in a single test. However, when test data includes a large number of parameters, e.g., as in IPv4 packets, for example, there are a numerous number of combinations of values of the parameters, so that the test period will be extended, and this will make the execution of the test difficult.

The testing system 10 according to the embodiment generates additional test data (second test data) based on a pair of test data (first test data) and the corresponding determination result acquired from the first test. In the second test data, any one of the parameters included in the second test data is assigned with a value within the result-unknown area positioning between a plurality of pieces of first test data resulting in different determination results.

For example, assuming that the threshold at which the determination result is switched is detected to be within the range equal to or greater than 10 and equal to or less than 20 in the first test, the testing system 10 generates the second test data including the length with a value within the range (e.g., 15), and executes the second test. If a problem occurs with a length=15, the range of the threshold can be narrowed down to equal to or greater than 10 and equal to or less than 15. By contrast, if no problem occurs with a length=15, the range of the threshold can be narrowed down to equal to or greater than 15 and equal to or less than 20.

In this manner, the testing system 10 according to the embodiment generates the test data within a range near the threshold, instead of randomly generating the test data used in the second test and tests thereafter. Therefore, the testing system 10 according to the embodiment can generate highly accurate boundary information with a smaller amount of test data, compared with when the boundary information is inferred from a single test.

### Second Embodiment

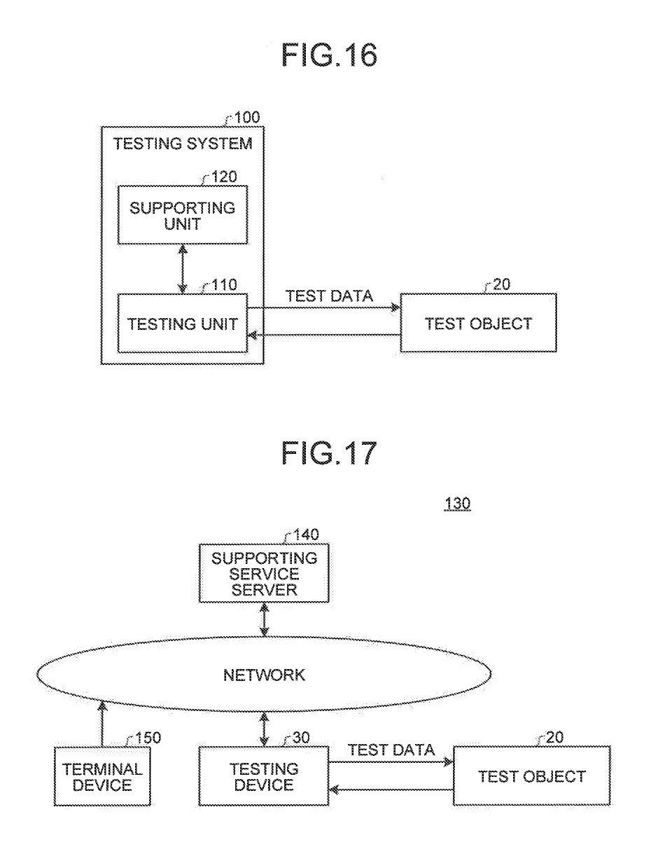

FIG. 16 is a schematic illustrating a configuration of a testing system 100 according to a second embodiment together with the test object 20. The testing system 100 according to the second embodiment is implemented as one information processing apparatus, for example. The testing system 100 includes a testing unit 110 and a supporting unit 120. The testing unit 110 has the same configuration and function as the testing device 30 according to the first embodiment. The supporting unit 120 has the same configuration and function as the supporting device 40 according to the first embodiment. Such a testing system 100 can implement the function that is the same as the testing system 10 according to the first embodiment with one information processing apparatus.

### Third Embodiment

FIG. 17 is a schematic illustrating a configuration of a testing system 130 according to a third embodiment together with the test object 20. The testing system 130 according to the third embodiment is implemented as a plurality of information processing apparatuses and a network.

The testing system 130 includes the testing device 30, a supporting service server 140, and a terminal device 150. The testing device 30 has the same configuration and function as that according to the first embodiment. The testing device 30 is connected to the supporting service server 140 over the network.

The supporting service server 140 is an information processing apparatus implemented as one or more computers connected to the network. The supporting service server 140 has the same configuration and function as the supporting device 40 according to the first embodiment. The supporting service server 140 is implemented as one server device, as an example. The supporting service server 140 may also be implemented as a computing environment (cloud) including a plurality of computers and a network.

The terminal device 150 is an information processing apparatus operated by a user. The terminal device 150 is connected to the testing device 30 and the supporting service server 140 over the network. The terminal device 150 operates the testing device 30 over the network, and controls to start or to end a test, for example. Furthermore, the terminal device 150 acquires the inference information and the like from the supporting service server 140 over the network, and presents such information to the user.

The network allows devices to exchange information using standard protocols such as Transmission Control Protocol (TCP) and Hyper Text Transfer Protocol (HTTP). Such a testing system 130 can implement the same functions as those of the testing system 10 according to the first embodiment, using a plurality of information processing apparatuses and a network.

Hardware Configuration

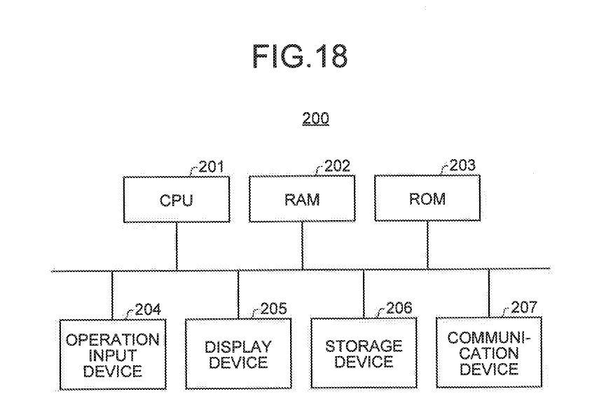

FIG. 18 is a schematic illustrating a hardware configuration of an information processing apparatus 200 according to the embodiments. Both of the testing device 30 and the supporting device 40 are implemented by the information processing apparatus 200 having a hardware configuration such as illustrated in FIG. 18.

This information processing apparatus 200 includes a central processing unit (CPU) 201, a random access memory (RAM) 202, a read-only memory (ROM) 203, an operation input device 204, a display device 205, a storage device 206, and a communication device 207. These devices are connected to one another over a bus.

The CPU 201 is a processor for executing arithmetic operations, controlling operations, and the like in accordance with a computer program. The CPU 201 execute various operations by cooperating with a computer program stored in the ROM 203, the storage device 206, or the like, using a predetermined area of the RAM 202 as a working area.

The RAM 202 is a memory such as a synchronous dynamic random access memory (SDRAM) or the like. The RAM 202 serves as a working area of the CPU 201. The ROM 203 is a memory storing therein computer programs and various types of information unrewritably.

The operation input device 204 is an input device such as a mouse, a keyboard and the like. The operation input device 204 receives information input by an operation of the user as an instruction signal, and outputs the instruction signal to the CPU 201.

The display device 205 is a display device such as a liquid crystal display (LCD) or the like. The display device 205 displays various types of information based on display signals received from the CPU 201.

The storage device 206 is a device for writing data to and reading data from a recording medium such as those using a semiconductor including a flash memory, or a recording medium capable of magnetically or optically recording, for example. The storage device 206 writes data to and reads data from the recording medium under the control of the CPU 201. The communication device 207 communicates with external devices over the network under the control of the CPU 201.

The computer program executed by the testing device 30 has a modular configuration including an initial data generating module, a data output module, an observing module, determining module, and a result output module. The computer program causes an information processing apparatus to function as the initial data generating unit 51, the data output unit 52, the observing unit 53, the determining unit 54, and the result output unit 55, by causing the CPU 201 (processor) to load the computer program onto the PAM 202 and executing the computer program. The testing device 30 may have a configuration implementing at least some of the initial data generating unit 51, the data output unit 52, the observing unit 53, the determining unit 54, and the result output unit 55 as a hardware circuit (such as a semiconductor integrated circuit), without limitation to the configuration described above.

The computer program executed by the supporting device 40 has a modular configuration including a result acquiring module, a result storing module, a generating module, a supplying module, an inferring module, and a presenting module. The computer program causes an information processing apparatus to function as the result acquiring unit 61, the result storage unit 62, the generating unit 63, the supplying unit 64, the inferring unit 65, and the presenting unit 66 by causing the CPU 201 (processor) to load the computer program onto the PAM 202 and to execute the computer program. The supporting device 40 may have a configuration implementing at least some of the result acquiring unit 61, the result storage unit 62, the generating unit 63, the supplying unit 64, the inferring unit 65, and the presenting unit 66 as a hardware circuit (such as a semiconductor integrated circuit), without limitation to the configuration described above.

Furthermore, the computer program executed by the testing device 30 or the supporting device 40 is provided and recorded in a computer-readable recording medium such as a compact disk read-only memory (CD-ROM), a flexible disk, compact disk recordable (CD-R), a digital versatile disk (DVD), as a file in a computer-installable or executable format.

Furthermore, the computer program executed by the testing device 30 or the supporting device 40 may be configured to be stored in a computer connected to a network such as the Internet, and to be provided by making available for download over the network. Furthermore, the computer program executed by the testing device 30 or the supporting device 40 may be configured to be provided or distributed over a network such as the Internet. Furthermore, the computer program executed by the testing device 30 or the supporting device 40 may also be provided in a manner incorporated in a ROM or the like in advance.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An information processing apparatus comprising:
a result acquiring unit configured to acquire a pair of first test data fed to a test object and a determination result indicating an operating state of the test object when the first test data is fed; and
a generating unit configured to generate second test data based on the pair of the first test data and the determination result, wherein
the generating unit is configured to select two pieces of the first test data with different determination results, and to generate the second test data by generating test data with values falling within an intermediary area between the two selected pieces of the first test data more frequently than generating test data with values outside of the intermediary area.

2. The information processing apparatus according to claim 1, wherein the intermediary area includes a set of pieces of test data, and
each of the pieces of test data belonging to the intermediary area has a parameter with a value that falls within a closed interval from a smaller value to a larger value.

3. The information processing apparatus according to claim 2, wherein
the information processing apparatus operates in a coordinated manner with a first device configured to feed test data, and
the information processing apparatus further comprises:
a supplying unit configured to supply the second test data to the first device.

4. The information processing apparatus according to claim 3, wherein the result acquiring unit is configured to acquire the pair of the first test data fed to the test object by the first device and the determination result.

5. The information processing apparatus according to claim 4, wherein the result acquiring unit is configured to acquire the determination result indicating whether an operation of the test object is good or no-good when the first test data is fed.

6. The information processing apparatus according to claim 2, wherein the generating unit is configured to select two pieces of the first test data with different determination results, in such a manner that there is no any other piece of the first test data in the intermediary area.

7. The information processing apparatus according to claim 6, wherein the generating unit is configured to select two pieces of the first test data with different determination results, and including parameters having a shortest distance therebetween.

8. The information processing apparatus according to claim 6, wherein the generating unit is configured to select two pieces of the first test data with different determination results, and including a largest number of parameters having a same value.

9. The information processing apparatus according to claim 6, wherein the generating unit is configured to generate two pieces of the second test data with swapped values of some of the parameters included in the two selected pieces of the first test data.

10. The information processing apparatus according to claim 6, wherein the generating unit is configured to generate the second test data having, as a value of each of the parameters, an average value of parameters corresponding to the two selected pieces of the first test data.

11. The information processing apparatus according to claim 1, further comprising:
a result storage unit configured to store therein a pair of the first test data fed to the test object and a determination result indicating an operating state of the test object when the first test data is fed;
a repetition control unit configured to cause the result acquiring unit to acquire a pair of the second test data fed to the test object and a determination result indicating an operating state of the test object when the second test data is fed, configured to cause the result storage unit to add and to store therein the acquired pair of the second test data and the determination result as a new pair of first test data and the determination result, and configured to cause the generating unit to generate new second test data based on the pair of the first test data and the determination result stored in the result storage unit.

12. The information processing apparatus according to claim 1, further comprising an inferring unit configured to infer boundary information representing a threshold of the parameter at which the determination result becomes switched, and the determination result representing areas separated by the threshold.

13. The information processing apparatus according to claim 12, further comprising:
a verification data generating unit configured to generate verification test data including parameters belonging to respective areas that sandwich the threshold, based on the boundary information; and
a verifying unit configured to verify whether the determination result indicating the operating state of the test object when the verification test data is fed and prediction information that is a prediction of the determination result match, and configured to cause the boundary information to be output when the determination result and the prediction information match.

14. A testing system comprising:
the first device configured to feed test data including at least one parameter to the test object; and
the information processing apparatus according to claim 3.

15. An information processing method comprising:
acquiring a pair of first test data fed to a test object and a determination result indicating an operating state of the test object when the first test data is fed; and
generating second test data based on the pair of the first test data and the determination result, wherein
the generating includes selecting two pieces of the first test data with different determination results,
the second test data is generated by generating test data with values falling within an intermediary area between the two selected pieces of the first test data more frequently than generating test data with values outside of the intermediary area.

16. A non-transitory computer-readable recording medium that stores therein a computer program causing an information processing apparatus to function as:
a result acquiring unit configured to acquire a pair of first test data fed to a test object and a determination result indicating an operating state of the test object when the first test data is fed; and
a generating unit configured to generate second test data based on the pair of the first test data and the determination result, wherein
the generating unit is configured to select two pieces of the first test data with different determination results, and to generate the second test data by generating test data with values falling within an intermediary area between the two selected pieces of the first test data more frequently than generating test data with values outside of the intermediary area.
